(19) United States
(12) Patent Application Publication
(10) Pub. No.: US 2007/0164976 A1
(43) Pub. Date: Jul. 19, 2007

(54) BACKLIGHT MODULE OF A DISPLAY PANEL

(76) Inventors: Chung-Huwa Kuo, Chiayi County (TW); Chung-Kuang Tsai, Hsinchu County (TW); Jian-Shen Li, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/308,116

(22) Filed: Mar. 7, 2006

(30) Foreign Application Priority Data
Jan. 13, 2006 (TW) 095101495

(51) Int. Cl. G09G 3/36

(52) U.S. Cl. 345/102

(57) ABSTRACT

A backlight module of a display panel includes a first light source, a second light source, a first inverter, and a second inverter. The first light source is disposed on a first side of the display panel and includes a first light-emitting device and a second light-emitting device. The second light source is disposed on a second side of the display panel and includes a third light-emitting device and a fourth light-emitting device. The first inverter is coupled to the first and third light-emitting devices, and the second inverter is coupled to the second and fourth light-emitting devices.

### BACKGROUND OF THE INVENTION

1. Field of the Invention

The present invention relates to a backlight module of a display panel, and more particularly, to a backlight module of a display panel capable of reducing image distortion and power consumption.

2. Description of the Prior Art

With lower prices and improving display quality, liquid crystal displays have been widely applied in various products such as notebook computers, personal digital assistants (PDAs), mobile phones, monitors, or flat panel televisions. Backlight modules are important components of liquid crystal displays due to their ability to provide a light source for achieving night-vision and full-color displays. A backlight module, generally disposed at the backside of a display panel, includes light-generating devices and a diffusing plate in order to project uniform light onto the display panel. Images can then be displayed by controlling the pixel electrodes of the display panel.

Conventionally, cold cathode fluorescent lamps (CCFLs), external electrode fluorescent lamps (EEFLs), or light emitted diodes (LEDs) are commonly used as the light-generating devices of the backlight modules. Based on the locations of the light-generating devices, the backlight modules can be categorized into two major types: direct type backlight modules and edge light type backlight modules. In the direct type backlight modules, light is provided directly from the backside of the panels. Therefore, the direct type backlight modules can generate stronger light and are particularly suitable in large-sized or high-brightness applications, such as display panels used in computer monitors and flat panel televisions. In the edge light type backlight modules, the light-generating devices are disposed at the laterals of the panels. Therefore, the edge light type backlight modules are smaller, less expensive, and particularly suitable for small-sized display devices. Both the direct type backlight modules and the edge light type backlight modules focus on improving the light uniformity, or the luminance, of the backlight modules. In addition, power consumption is also a major concern when designing a good backlight module.

Please refer to FIG. 1 for a diagram of a prior art backlight module 10. The backlight module 10 has the edge light type structure and includes light-generating devices 11-14, an inverter 15, and a control circuit 16. The light-generating devices 11 and 12 are disposed at a first side of the backside of a display panel 18, and the light-generating devices 13 and 14 are disposed at a second side of the backside of a display panel 18. The light-generating devices 11-14 are coupled to the inverter that controls the luminance of the light-generating devices 11-14. According to images to be displayed by the display panel 18, the backlight module 10 generates a control voltage V using the control circuit 16, and sends the control voltage V to the inverter 15. The inverter 15 then generates a corresponding driving current I for the light-generating devices 11-14. In the prior art backlight module 10, the light-generating devices 11-14 are simultaneously turned on or simultaneously turned off, thereby providing the same luminance. When a user wants to adjust the screen brightness of the display panel 18, the backlight 10 adjusts the value of the driving current I so that each light-emitting device can provide corresponding luminance. It is preferable to design backlight modules with wider adjusting ranges for brightness. However, due to the limitation of the light-emitting devices, the value of the driving current I can only be varied within a certain range.

Please refer to FIG. 2 for a signal diagram illustrating the operations of the light-generating devices of the prior art backlight module 10. In FIG. 2, the transverse axle represents on-screen display (OSD) control signal. By adjusting the value of the OSD control signal, different parameters of the display panel 18, such as those corresponding to color, contrast, brightness, operation modes of the display panel 18, can be adjusted as required by the user. In FIG. 2, the OSD control signal is used as the brightness control signal with an adjusting range from 1 to 100. A higher OSD value corresponds to higher brightness. In FIG. 2, the left transverse axle represents the value of the driving current (milli-ampere, mA) and the right transverse axle represents the value of the control voltage (volt, V). A curve designated as “A” illustrates how the driving current I varies with the OSD control signal, and a curve designated as “B” illustrates how the control voltage V varies with the OSD control signal. In FIG. 2, the sampling interval of the OSD control signal is the integer 5. The corresponding values of the driving current I and the control voltage V when the OSD control signal is a multiple of 5 are represented by numbers marked above “.” on the curve A and “▴” on the curve B, respectively.

As shown in FIG. 2, due to the limitation of the light-emitting devices, when the OSD control signal is smaller than a threshold value (OSD=30), the control voltage V and the driving current I will not decrease accordingly, but remain at the values corresponding to OSD=30. At this time, the luminance of the backlight module 10 is fixed. If the user still wants to decrease the screen brightness to a value lower than that corresponding to OSD=30, digital data processing has to be employed for simulating corresponding low-brightness images. This method results in image distortion and influences the display quality of the display panel 18. Also, the ideal operating current range of the light-emitting devices in the backlight modules is between 3-8.5 mA. When driving a light-emitting device using a small current outside its ideal operating current range, it results in inconsistent brightness and flicker. Therefore, when operating with low OSD control signal, the driving current I is normally set to a value around 3.5 mA (which corresponds to OSD=40) in order to guarantee display quality. As a result, the user can only lower the brightness to 40% of the maximum brightness without causing image distortion. If the brightness needs to be lowered further, digital data processing has to be employed, which inevitably results in image distortion.

In the prior art backlight module 10, the light-generating devices cannot provide high quality images with a low driving current. Since the driving current cannot ideally decrease according to the control signal, digital data processing has to be employed for simulating low brightness images, which inevitably results in image distortion.

### SUMMARY OF THE INVENTION

The claimed invention provides a backlight module used for display panels comprising a first light source disposed on a first side of a display panel, the first light source comprising a first light-generating device and a second light-generating device; a second light source disposed on a second side of the display panel, the second light source comprising a third light-generating device and a fourth light-generating device; a first inverter coupled to the first and second light-generating devices; and a second inverter coupled to the third and fourth light-generating devices.

The claimed invention further provides a backlight module used for display panels comprising a first light source disposed on a first side of a display panel, the first light source comprising a plurality of first light-generating devices and a plurality of second light-generating devices, wherein the first and second light-generating devices are disposed in parallel with each other in an alternating manner; a second light source disposed on a second side of the display panel, the second light source comprising a plurality of third light-generating devices and a plurality of fourth light-generating devices, wherein the third and fourth light-generating devices are disposed in parallel with each other in an alternating manner; a first inverter coupled to the first light-generating devices of the first light source and the third light-generating devices of the second light source; and a second inverter coupled to the second light-generating devices of the first light source and the fourth light-generating devices of the second light source.

The claimed invention further provides a method for driving a backlight module of a display panel comprising detecting the brightness of images to be displayed by a display panel; and when the brightness of images to be displayed by the display panel is smaller than a predetermined value, turning on light-generating devices of a first light source disposed at a first side of the display panel and turning off light-generating devices of a first light source disposed at a second side of the display panel using a first control unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a prior art backlight module.

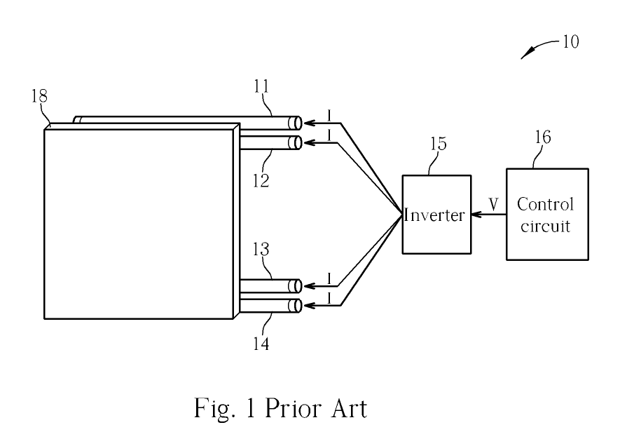

FIG. 2 is a signal diagram illustrating the operations of the light-generating devices of the backlight module in FIG. 1.

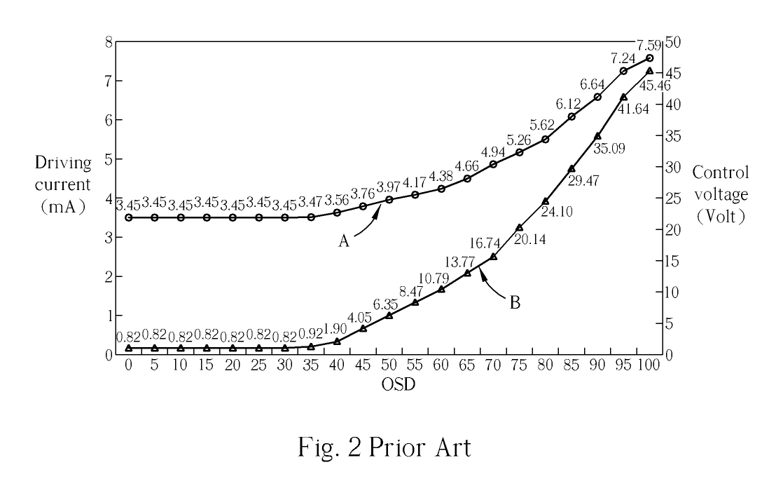

FIG. 3 is a diagram of a backlight module according to a first embodiment of the present invention.

FIG. 4 is a diagram of a backlight module according to a second embodiment of the present invention.

FIG. 5 is a flowchart illustrating the operations of the backlight modules in FIGS. 3 and 4.

FIG. 6 is a diagram of a backlight module according to a third embodiment of the present invention.

FIG. 7 is a diagram of a backlight module according to a fourth embodiment of the present invention.

FIG. 8 is a flowchart illustrating the operations of the backlight modules in FIGS. 7 and 8.

### DETAILED DESCRIPTION

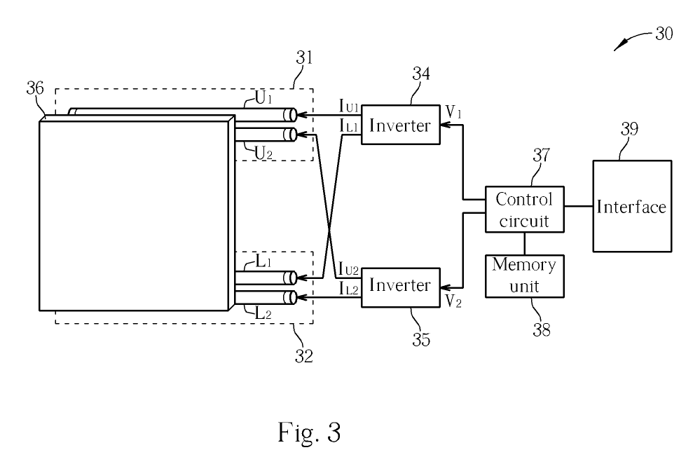

Please refer to FIG. 3 for a diagram of a backlight module 30 according to a first embodiment of the present invention. The backlight module 30 includes two light sources 31 and 32, two inverters 34 and 35, a control circuit 37, a memory unit 38, and an interface 39. The user can adjust parameters, such as those corresponding to color, contrast, brightness, or operation modes of a display panel 36, via the interface 39. The control circuit 37 is coupled to the inverters 34 and 35 and generates control voltages V₁ and V₂ based on received control signals. The memory unit 38 can include an electrically erasable programmable read only memory (EEPROM) or other types of memory for data storage. The backlight unit 30 has an edge light type structure, in which the light sources 31 and 32 are disposed at the two sides of the backside of the display panel 36. In the first embodiment, the light source 31 includes two light-generating devices U₁ and U₂, and the light source 32 includes two light-generating devices L₁ and L₂. The inverter 34, coupled to the light-generating devices U₁ and L₁, respectively generates driving currents I_{U1} and I_{L1} for the light-generating devices U₁ and L₁ based on the control voltage V₁. The inverter 35, coupled to the light-generating devices U₂ and L₂, respectively generates driving currents I_{U2} and I_{L2} for the light-generating devices U₂ and L₂ based on the control voltage V₂. In the backlight module 30, each inverter can drive two light-generating devices. The light-generating devices U₁, U₂, L₁ and L₂ can include CCFLs, EEFLs, or LEDs.

When the display panel 36 displays images with luminance lower than a predetermined value (such as 50% of the maximum luminance), the backlight unit 30 of the present invention has two operational modes:

(1) Operational mode 1: the inverter 34 turns on the light-generating devices U₁ and turns off light-generating devices L₁, while the inverter 35 turns on the light-generating devices L₂ and turns off light-generating devices U₂;

(2) Operational mode 2: the inverter 34 turns off the light-generating devices U and turns on light-generating devices L₁, while the inverter 35 turns off the light-generating devices L₂ and turns on light-generating devices U₂.

In other words, only one light-generating device in each of the light sources 31 and 32 is turned on for providing light when the display panel 36 displays images with luminance lower than 50% of the maximum luminance. The luminance of the turned-on light-generating devices is determined based on the required brightness of the display images. For illustrating the present invention, the OSD control signal is again used as the brightness control signal with an adjusting range from 1 to 100. A higher OSD value corresponds to higher brightness. For example, when the user sets the OSD control signal to 100 via the interface 39, the inverters 34 and 35 simultaneously turn on the light-generating devices U₁, U₂, L₁ and L₂, and generate driving currents required by corresponding light-generating devices in order to provide maximum luminance. When the user sets the OSD control signal to 80 via the interface 39, the inverters 34 and 35 simultaneously turn on the light-generating devices U₁, U₂, L₁ and L₂, and generate driving currents required by corresponding light-generating devices in order to provide 80% of the maximum luminance. When the user sets the OSD control signal to 50 via the interface 39, the inverters 34 and 35 turn off two of the four light-generating devices (such as the light-generating devices U₂ and L₁ in operational mode 1, or the light-generating devices U₁ and L₂ in operational mode 2), and generate driving currents required by corresponding turned-on light-generating devices in order to provide maximum luminance. When the user sets the OSD control signal to 30 via the interface 39, the inverters 34 and 35 turn off two of the four light-generating devices (such as the light-generating devices U₂ and L₁ in operational mode 1, or the light-generating devices U₁ and L₂ in operational mode 2), and generate driving currents required by corresponding turned-on light-generating devices in order to provide 60% of the maximum luminance.

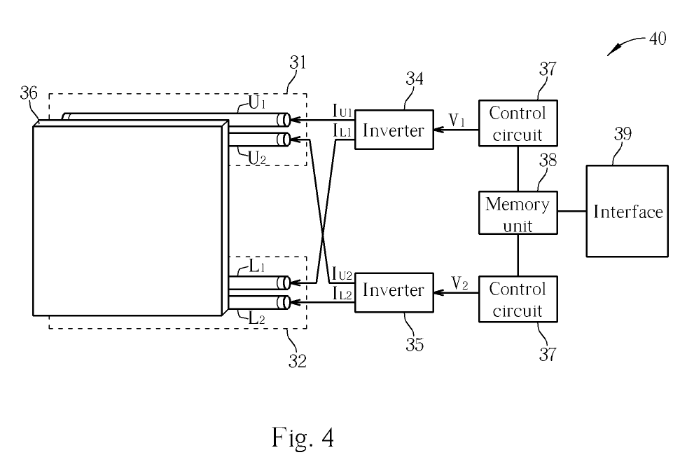

In the backlight unit 30 according to the first embodiment of the present invention, the control circuit 37 can include a micro-processing unit (MPU) capable of generating the control voltages V₁ and V₂ for the inverters 34 and 35. However, the present invention can also include a plurality of MPUs for generating the control voltages V₁ and V₂ for the inverters 34 and 35. Please refer to FIG. 4 for a diagram of a backlight module 40 according to a second embodiment of the present invention. The backlight module 40 includes two control circuits 37 for generating the control voltages V₁ and V₂ for the inverters 34 and 35, respectively.

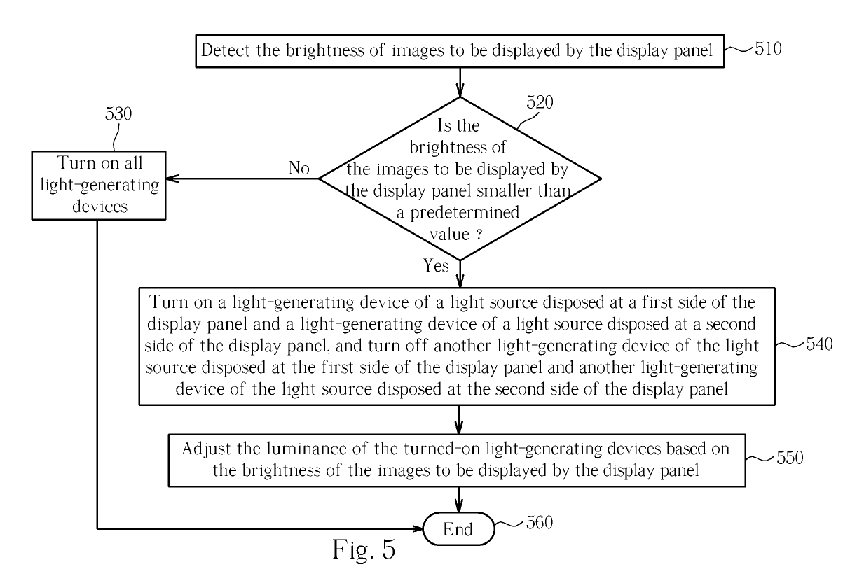

Please refer to FIG. 5 for a flowchart illustrating the operations of the backlight modules 30 and 40 according to the first and second embodiments of the present invention. The flowchart in FIG. 5 includes the following steps:

Step 510: detect the brightness of images to be displayed by the display panel 36;

Step 520: determine if the brightness of the images to be displayed by the display panel 36 is smaller than a predetermined value; if the brightness of the images is smaller than a predetermined value, execute step 540; if the brightness of the images is not smaller than a predetermined value, execute step 530;

Step 530: turn on all light-generating devices; execute step 560;

Step 540: turn on a light-generating device of a light source disposed at a first side of the display panel 36 and a light-generating device of a light source disposed at a second side of the display panel 36, and turn off another light-generating device of the light source disposed at the first side of the display panel 36 and another light-generating device of the light source disposed at the second side of the display panel 36;

Step 550: adjust the luminance of the turned-on light-generating devices based on the brightness of the images to be displayed by the display panel 36; and

Step 560: end.

In the prior art backlight modules, all the light-generating devices are turned on and the luminance of each light-generating device is set to the same value based on the display images. When the brightness needs to be set to a value lower than 40% of the maximum luminance, digital data processing has to be employed, which inevitably results in image distortion. In the backlight modules 30 and 40 of the present invention, only two light-generating devices each disposed at the two sides of the backside of the display panel 36 are turned on for providing light when the display panel 36 displays images with luminance lower than 50% of the maximum luminance. With only half of the light-generating devices being turned on, the brightness can be lowered to 50% of the maximum value, and the luminance of the turned-on light-generating devices can be adjusted based on display images. Therefore, the backlight modules 30 and 40 of the present invention can provide a wider range for brightness adjustment, as well as for other parameter adjustments, without causing image distortion. In addition, when the display panel 36 displays images with luminance lower than 50% of the maximum luminance, the two turned-on light-generating devices are each disposed at the two sides of the backside of the display panel 36. Therefore, the present invention can provide uniform illumination even when the light-generating devices have low-brightness luminance.

The backlight modules 30 and 40 of the present invention can also reduce power consumption. Due to the characteristics of the light-generating devices, the voltage of a light-generating device increases with decreasing driving current. For example, a light-generating device driven by a 6 mA driving current results in a voltage around 600 volt, while a light-generating device driven by a 3 mA driving current results in a voltage around 700 volt. For providing the same illumination, the four light-generating devices of the prior art backlight module 10 are each driven with a 3 mA driving current, while the two light-generating devices of the backlight module 30 according to the present invention are each driven with a 6 mA driving current. As a result, the power consumption P10, P30 and P40 of the backlight modules 10, 30 and 40 can be represented as follows:

P10≈4*700*3=8.4 (watt);

P30=P40≈2*600*6=7.2 (watt).

Therefore, when providing the same illumination, the present invention can reduce 15% of the power consumption.

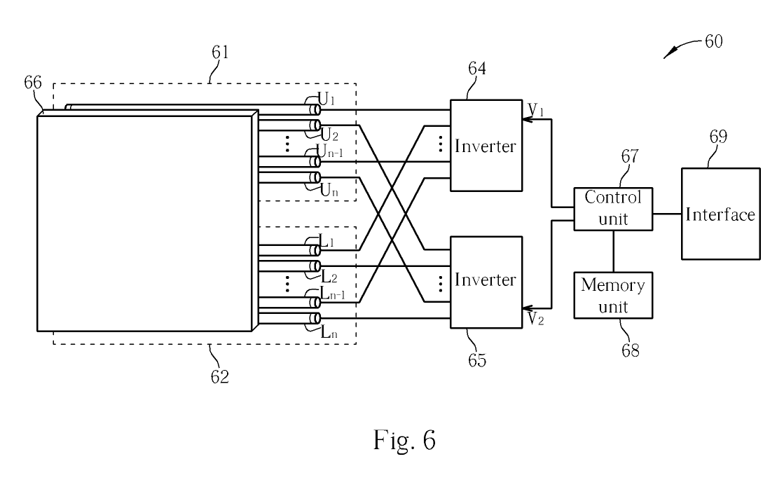

Please refer to FIG. 6 for a diagram of a backlight module 60 according to a third embodiment of the present invention. The backlight module 60 includes two light sources 61 and 62, two inverters 64 and 65, a control circuit 67, a memory unit 68, and an interface 69. The user can adjust parameters, such as those corresponding to color, contrast, brightness, or operation modes of a display panel 66, via the interface 69. The control circuit 67 is coupled to the inverters 64 and 65 and generates control voltages V₁ and V₂ based on received control signals. The memory unit 68 can include an EEPROM or other types of memory for data storage. The backlight unit 60 has an edge light type structure, in which the light sources 61 and 62 are disposed at the two sides of the backside of the display panel 66. In the third embodiment, the light source 61 includes a plurality of light-generating devices U₁-Uₙ, and the light source 62 includes a plurality of light-generating devices L₁-L₂ₙ. The inverter 34, coupled to the odd-numbered light-generating devices U₁-Uₙ₋₁ of the light source 61 and the odd-numbered light-generating devices L₁-Lₙ₋₁ of the light source 62, generates driving currents for the corresponding odd-numbered light-generating devices based on the control voltage V₁. The inverter 65, coupled to the even-numbered light-generating devices U₂-Uₙ of the light source 61 and the even-numbered light-generating devices L₂-Lₙ of the light source 62, generates driving currents for the corresponding even-numbered light-generating devices based on the control voltage V₂. In the backlight module 60, each inverter can drive n light-generating devices. Two neighboring light-generating devices in each of the light sources are controlled by different inverters. The light-generating devices U₁-Uₙ and L₁-Lₙ can include CCFLs, EEFLs, or LEDs.

When the display panel 66 displays images with luminance lower than a predetermined value (such as 50% of the maximum luminance), the backlight unit 60 of the present invention has two operational modes:

(1) Operational mode 3: the inverter 64 turns on the odd-numbered light-generating devices U₁-Uₙ₋₁ of the light source 61 and turns off the odd-numbered light-generating devices L₁-Lₙ₋₁ of the light source 62, while the inverter 65 turns on the even-numbered light-generating devices L₂-Lₙ of the light source 62 and turns off the even-numbered light-generating devices U₂-Uₙ of the light source 61;

(2) Operational mode 4: the inverter 64 turns off the odd-numbered light-generating devices U₁-Uₙ₋₁ of the light source 61 and turns on the odd-numbered light-generating devices L₁-Lₙ₋₁ of the light source 62, while the inverter 65 turns off the even-numbered light-generating devices L₂-Lₙ of the light source 62 and turns on the even-numbered light-generating devices U₂-Uₙ of the light source 61.

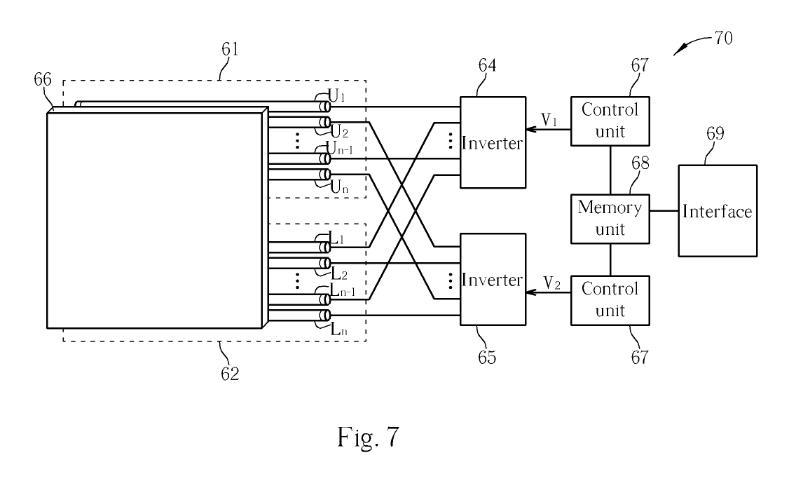

In other words, only half of the light-generating devices in each of the light sources 61 and 62 are turned on for providing light when the display panel 66 displays images with luminance lower than 50% of the maximum luminance. The luminance of the turned-on light-generating devices is determined based on the required brightness of the display images. In the backlight unit 60 according to the third embodiment of the present invention, the control circuit 67 can include an MPU capable of generating the control voltages V₁ and V₂ for the inverters 64 and 65. However, the present invention can also include a plurality of MPUs for generating the control voltages V₁ and V₂ for the inverters 64 and 65. Please refer to FIG. 7 for a diagram of a backlight module 70 according to a fourth embodiment of the present invention. The backlight module 70 includes two control circuits 67 for generating the control voltages V₁ and V₂ for the inverters 64 and 65, respectively.

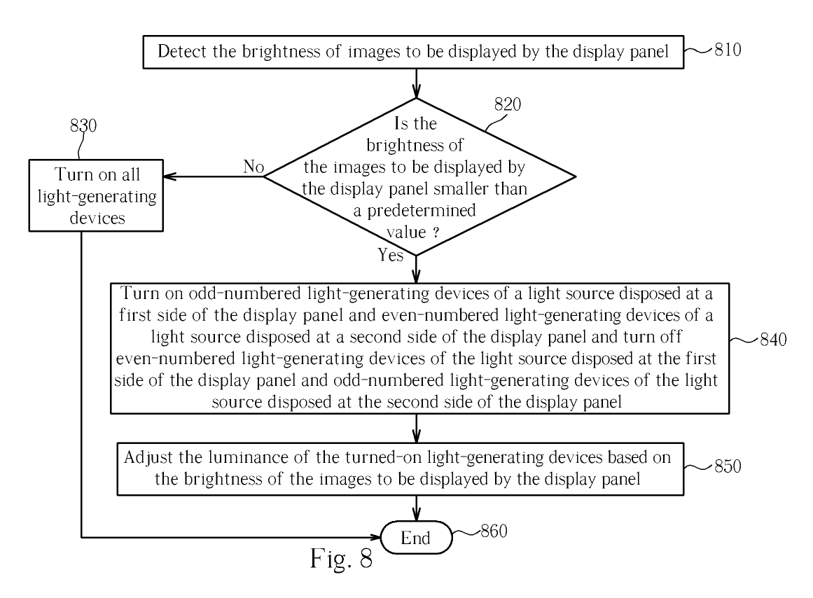

Please refer to FIG. 8 for a flowchart illustrating the operations of the backlight modules 60 and 70 according to the third and fourth embodiments of the present invention. The flowchart in FIG. 8 includes the following steps:

Step 810: detect the brightness of images to be displayed by the display panel 66;

Step 820: determine if the brightness of the images to be displayed by the display panel 66 is smaller than a predetermined value; if the brightness of the images is smaller than a predetermined value, execute step 840; if the brightness of the images is not smaller than a predetermined value, execute step 830;

Step 830: turn on all light-generating devices; execute step 860;

Step 840: turn on odd-numbered light-generating devices of a light source disposed at a first side of the display panel 66 and even-numbered light-generating devices of a light source disposed at a second side of the display panel 66, and turn off even-numbered light-generating devices of the light source disposed at the first side of the display panel 66 and odd-numbered light-generating devices of the light source disposed at the second side of the display panel 66;

Step 850: adjust the luminance of the turned-on light-generating devices based on the brightness of the images to be displayed by the display panel 66; and

Step 860: end.

When the prior art backlight modules are used for displaying low-brightness images, digital data processing has to be employed, which inevitably results in image distortion. In the backlight modules of the present invention, only half of the light-generating devices of the two light sources, each disposed at the two sides of the backside of the display panel 36, are turned on for providing light when the display panel displays images with luminance lower than a predetermined value. With only half of the light-generating devices being turned on, the brightness can be lowered to 50% of the maximum value, and the luminance of the turned-on light-generating devices can be adjusted based on display images. Therefore, the backlight modules of the present invention can provide a wider range for brightness adjustment, as well as for other parameter adjustments, without causing image distortion. In addition, the present invention can also provide uniform illumination and reduce power consumption.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A backlight module used for display panels comprising:
a first light source disposed on a first side of a display panel, the first light source comprising a first light-generating device and a second light-generating device;
a second light source disposed on a second side of the display panel, the second light source comprising a third light-generating device and a fourth light-generating device;
a first inverter coupled to the first and second light-generating devices; and
a second inverter coupled to the third and fourth light-generating devices.

2. The backlight module of claim 1 further comprising:
a first inverter control circuit coupled to the first inverter; and
a second inverter control circuit coupled to the second inverter.

3. The backlight module of claim 2 wherein each inverter control circuit includes a micro-processing unit (MPU).

4. The backlight module of claim 1 further comprising an inverter control circuit coupled to the first and second inverters.

5. The backlight module of claim 4 wherein the inverter control circuit includes an MPU.

6. The backlight module of claim 1 wherein the light-generating devices include cold cathode fluorescent lamps (CCFLs), external electrode fluorescent lamps (EEFLs), or light emitting diodes (LEDs).

7. A backlight module used for display panels comprising:
a first light source disposed on a first side of a display panel, the first light source comprising a plurality of first light-generating devices and a plurality of second light-generating devices, wherein the first and second light-generating devices are disposed in parallel with each other in an alternating manner;
a second light source disposed on a second side of the display panel, the second light source comprising a plurality of third light-generating devices and a plurality of fourth light-generating devices, wherein the third and fourth light-generating devices are disposed in parallel with each other in an alternating manner;
a first inverter coupled to the first light-generating devices of the first light source and the third light-generating devices of the second light source; and
a second inverter coupled to the second light-generating devices of the first light source and the fourth light-generating devices of the second light source.

8. The backlight module of claim 7 further comprising:
a first inverter control circuit coupled to the first inverter; and
a second inverter control circuit coupled to the second inverter.

9. The backlight module of claim 8 wherein each inverter control circuit includes an MPU.

10. The backlight module of claim 7 further comprising an inverter control circuit coupled to the first and second inverters.

11. The backlight module of claim 10 wherein the inverter control circuit includes an MPU.

12. The backlight module of claim 7 wherein the light-generating devices include CCFLs, EEFLs, or LEDs.

13. A method for driving a backlight module of a display panel comprising:
detecting the brightness of images to be displayed by a display panel; and
when the brightness of images to be displayed by the display panel is smaller than a predetermined value, turning on light-generating devices of a first light source disposed at a first side of the display panel and turning off light-generating devices of a first light source disposed at a second side of the display panel using a first control unit.

14. The method of claim 13 further comprising:
when the brightness of images to be displayed by the display panel is not smaller than the predetermined value, turning on all light-generating devices of the first light source using the first control unit.

15. The method of claim 13 further comprising:
when the brightness of images to be displayed by the display panel is smaller than the predetermined value, turning on light-generating devices of a second light source disposed at the first side of the display panel and turning off light-generating devices of the second light source disposed at the second side of the display panel using a second control unit.

16. The method of claim 15 further comprising:
when the brightness of images to be displayed by the display panel is not smaller than the predetermined value, turning on all light-generating devices of the second light source using the second control unit.
